(19) United States
(12) Patent Application Publication
(10) Pub. No.: US 2006/0023064 A1
(43) Pub. Date: Feb. 2, 2006

(54) Method for privacy communication between video phones

(75) Inventors: Min Kyu Shim, Seoul (KR); Huen Joo Lee, Seoul (KR)

Correspondence Address: HARNESS, DICKEY & PIERCE, P.L.C., P.O. BOX 828, BLOOMFIELD HILLS, MI, 48303, US

(73) Assignee: C and S Technology Co., Ltd., Seoul (KR)

(21) Appl. No.: 10/899,764

(22) Filed: Jul. 27, 2004

(51) Int. Cl. H04N 7/14

(52) U.S. Cl. 348/14.12; 348/14.01

(57) ABSTRACT

Privacy during communication between video phone terminals is enhanced by eradicating the possibility of eavesdropping through lip reading. Image data on the screen is processed so as not to be recognizable by a third party. Voice data is encrypted and the encrypted data is transmitted and receive. The received data is then decrypted by decoding. The video phone terminal of transmitting side transmits the specially processed entire area or selected area of a picture data so that it will not be recognizable by a third party who does not take part in privacy communication in a video phone terminal of receiving side. The video phone terminal of receiving side receives the processed picture data and recovers the specially processed entire area or selected area of a picture data according to the method processed in video phone terminal of transmitting side.

### BACKGROUND OF THE INVENTION

1. Field of the Invention

The present invention relates to a method for privacy communication between video phone terminals, in more detail, a method for eradicating the possibility of eavesdropping through lip reading by processing image data on the screen not to be recognizable for a third party in order to complement secrecy of video phones with only voice data encryption in privacy communication.

With the advance of communication network in modern society, when the respect that communication is being widely applied to all areas of our lives is taken into consideration, one can be damaged by privacy exposure in the case that signals being transmitted and received through communication network which is in use privately are easily eavesdropped by others.

Likewise, in the case that enterprises having large amount of industrial information make use of said industrial information through communication network, the information can be easily eavesdropped, and on this account, enterprises can be unstable.

Especially, since such eavesdropping is linked directly with criminal arrest and national defense in police station and military corps respectively, it raises big problems.

As depicted above, with the advance of communication network, problems related to eavesdropping covering the society at large and the preservation for security guarantee of communication became prominent figures.

In one hand, with the advance on image compression techniques, the art on video phone showing image while talking over the telephone in Internet and wireless environment as well not to speak of plane old telephone line is being universal.

In the case of plane old telephone without using image, privacy communication is realized in the method that said plane old telephone transmits voice data in encrypted code to perform voice security, and decrypts received code to voice data, thereby voice security can be accomplished with this method.

By the way, in the case of video phone which also transmits and receives image along with voice, an embodiment of voice security is imperfect with only voice data encryption on account of the danger that a third party eavesdrops pictures which are transmitted and received between speakers through lip reading.

That is, video phone transmitting speaker image along with voice is in danger of being eavesdropped by a third party through lip reading (recognize other's dialogue with the shape of lip).

2. Description of the Related Art

The present invention is devised to solve the problems described above, and the objectives of the present invention reside in that the present invention provides a method to complement eavesdropping protection between video phones for privacy communication which aims at perfect communication security in eradication of eavesdropping possibility through lip reading, where video phones transmit entire picture in encryption or mouse part of speaker in special processing.

In the method for privacy communication between video phones in the way that voice data is encrypted and encrypted data is transmitted and received and then received data is decrypted by decoding: in order to accomplish the objectives described above, the present invention provides a method to complement eavesdropping protection between video phones for privacy communication which is characterized in that said video phone terminal of transmitting side transmits the specially processed entire or settled area of a picture data not to be recognizable for a third party who does not take part in privacy communication in a video phone terminal of receiving side, and video phone terminal of receiving side receives the processed picture data and recovers the specially processed entire or settled area of a picture data according to the method processed in video phone terminal of transmitting side.

### SUMMARY OF THE INVENTION

The present invention relates to a method for privacy communication between video phone terminals, in more detail, a method for eradicating the possibility of eavesdropping through lip reading by processing image data on the screen not to be recognizable for a third party, in order to complement secrecy of video phones with only voice data encryption in privacy communication. In the method for privacy communication between video phones in the way that voice data is encrypted and encrypted data is transmitted and received and then received data is decrypted by decoding: in order to accomplish the objectives described above, the present invention provides a method to complement eavesdropping protection between video phones for privacy communication which is characterized in that said video phone terminal of transmitting side transmits the specially processed entire or settled area of a picture data not to be recognizable for a third party who does not take part in privacy communication in a video phone terminal of receiving side, and video phone terminal of receiving side receives the processed picture data and recovers the specially processed entire or settled area of a picture data according to the method processed in video phone terminal of transmitting side.

### BRIEF DESCRIPTION OF THE DRAWINGS

FIG. 1 is a view illustrating a structure of video phone applied to the present invention.

### DESCRIPTION OF THE NUMERALS ON THE MAIN PARTS OF THE DRAWINGS

10, 20: an A/D converter
12: a picture processing unit
14: an image compression unit
22: a voice compression unit
24: a data encryption unit
30: a data transmission unit
40: a transmission network
50: a data receiving unit
60: an image decompression unit
62: a picture processing unit
64, 74: a D/A converter
70: a data decryption unit
72: a voice decompression unit

### DETAILED DESCRIPTION OF THE EMBODIMENTS

Hereinafter, referring to appended drawings, the structures and operation principles of the present invention are described in detail.

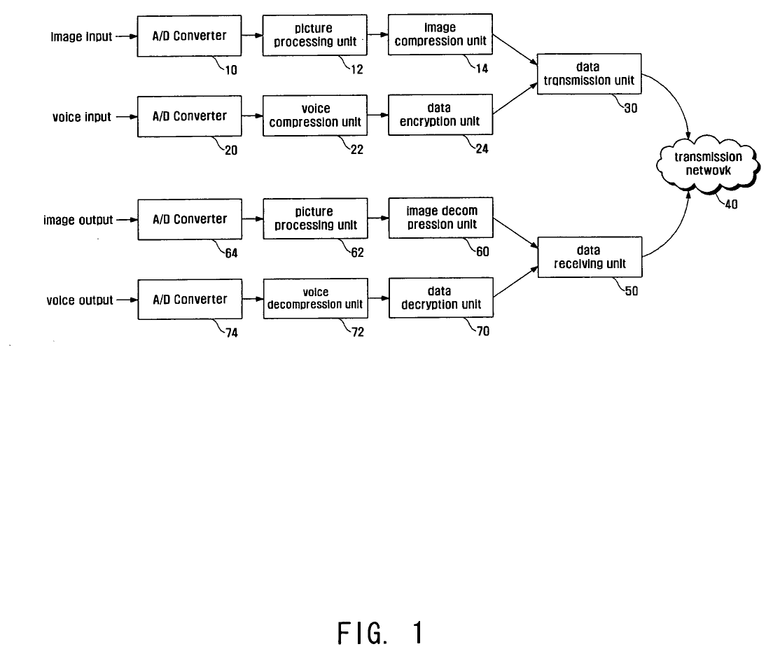

FIG. 1 is a view illustrating a structure of video phone applied to the present invention.

For an image signal in transmitting side, analog image input signal is converted to digital image signal in A/D converter (10), entire or settled area of each picture is specially processed in picture processing unit (12) not to be eavesdropped through lip reading, and specially processed data is compressed into the data having low transmission rate in image compression unit (14). Subsequently, compressed data is transmitted to transmission network (40) such as PSTN, Internet, and wireless network via data transmission unit (30).

For a voice signal in transmitting side, analog voice input signal is converted to digital voice signal in A/D converter (20), digital voice signal is compressed into the data having low transmission rate in voice compression unit (22), and encrypted privacy communication data is produced in data encryption unit (24). Subsequently, encrypted privacy communication data is transmitted to transmission network (40) such as PSTN, Internet, and wireless network via data transmission unit (30).

Picture processing method for digital image signal in said picture processing unit (12) can be the method by encryption or by mosaic based on picture manipulation.

Said mosaic is to display mosaic picture falsified from original picture, in which said mosaic picture can be produced in that each dot data which should be displayed on its own dot position in settled area in a picture is not displayed, but a randomly extracted dot data among said each dot data is displayed repeatedly on each dot position in said settled area in a picture.

Manual process that entire picture or part of picture settled by user is directly assigned to special processing area or automatic process that some area around mouth of speaker is automatically recognized to settle special processing area can be used as a method to assign special processing area in a picture.

Automatic process has the advantage of automatically compensating picture processing area around mouth of a picture supposing that speaker position is changed in the course of talking over telephone.

The method to process the settled area of a picture specially in above picture processing unit (12) can reduce operations in the system as compared with the method to process entire picture.

In receiving side, data receiving unit (50) receives compressed image data and encrypted voice data from transmission network (40) such as PSTN, Internet, and wireless network, image decompression unit (60) decompresses the compressed image data out of above two kinds of data, and picture processing unit (62) recovers settled area processed specially in a picture to original picture. Subsequently, D/A converter (64) converts recovered digital image signal to analog image signal, which is displayed on the screen.

Encrypted voice data is decrypted in data decryption unit (70), and the compressed voice data having low data transmission rate is decompressed in voice decompression unit (72). Subsequently, D/A converter (74) converts decompressed digital voice signal to analog voice signal, which is made a sound through a speaker.

Picture processing unit (62) in receiving side recovers settled area of a picture according to the special processing method for settled area in picture processing unit (12) of transmitting side.

That is, settled area processed specially by encryption is recovered in decryption, and settled area processed by mosaic is recovered in the reverse processing order of mosaic.

According to the present invention as described above, a perfect voice security can be realized by eradicating the possibility of eavesdropping through lib reading, where the data is transmitted and received in the way that entire picture is encrypted or mouth part of a picture is processed specially.

Since the method to process settled area of a picture specially can reduce operations in the system as compared with the method to process entire picture, a perfect voice security can be realized with relatively low cost in the case of settled area of a picture.

When the processing method capable of recognizing picture processing area automatically is used, there is no inconvenience for a user setting up picture processing area, and picture processing area is automatically compensated supposing that speaker position is changed in the course of talking over telephone.

Since those having ordinary knowledge and skill in the art of the present invention will recognize additional modifications and applications within the scope thereof, the present invention is not limited to the embodiments and drawings described above.

What is claimed is:

1. A method to complement eavesdropping protection for privacy communication between video phones comprising; characterized in that said video phone terminal of transmitting side transmits the specially processed entire or settled area of a picture data not to be recognizable for a third party who does not take part in privacy communication in a video phone terminal of receiving side, and video phone terminal of receiving side receives the processed picture data and recovers specially processed entire or settled area of a picture data according to the method processed in video phone terminal of transmitting side.

2. A method to complement eavesdropping protection for privacy communication between video phones as claimed in claim 1, characterized in that said video phone terminal of transmitting side processes entire picture data or settled area of a picture data with encryption, and video phone terminal of receiving side recovers entire picture data or settled area of a picture data with decryption.

3. A method to complement eavesdropping protection for privacy communication between video phones as claimed in claim 1, characterized in that said video phone terminal of transmitting side processes entire picture data or settled area of a picture data with mosaic, and video phone terminal of receiving side recovers entire picture data or settled area of a picture data with reverse order of mosaic.

4. A method to complement eavesdropping protection for privacy communication between video phones as claimed in claim 1, characterized in that said settled area of a picture data is the data around mouth of speaker.

5. A method to complement eavesdropping protection for privacy communication between video phones as claimed in claim 2, characterized in that said settled area of a picture data is the data around mouth of speaker.

6. A method to complement eavesdropping protection for privacy communication between video phones as claimed in claim 3, characterized in that said settled area of a picture data is the data around mouth of speaker.
